(19) United States
(12) Patent Application Publication
(10) Pub. No.: US 2020/0202829 A1
(43) Pub. Date: Jun. 25, 2020

(54) ULTRASONIC WAVE OUTPUT DEVICE

(71) Applicant: DENSO CORPORATION, Kariya-city (JP)

(72) Inventor: Toshiaki NAKAYAMA, Kariya-city (JP)

(21) Appl. No.: 16/807,773

(22) Filed: Mar. 3, 2020

Related U.S. Application Data
(63) Continuation of application No. PCT/JP2018/033962, filed on Sep. 13, 2018.

(30) Foreign Application Priority Data
Sep. 15, 2017 (JP) 2017-177538

(51) Int. Cl. G10K 11/02

(52) U.S. Cl. CPC G10K 11/025

(57) ABSTRACT

An ultrasonic wave output device includes an ultrasonic wave generator, a horn and a holder. The ultrasonic wave generator is configured to output an ultrasonic wave from a sound wave output surface in a predetermined propagation direction. The horn surrounds a space, which is located on a front side of the at least one ultrasonic wave generator in the propagation direction. The horn is configured such that a size of the space, which is surrounded by the horn, is progressively increased toward the front side in the propagation direction. The holder is placed between the ultrasonic wave generator and the horn and is made of a softer material, which is softer than a material of the ultrasonic wave generator. The holder is configured to hold the ultrasonic wave generator in an unarrested state where an outer peripheral edge of the sound wave output surface is not arrested.

### CROSS REFERENCE TO RELATED APPLICATIONS

This application is a continuation application of International Patent Application No. PCT/JP2018/033962 filed on Sep. 13, 2018, which designated the U.S. and claims the benefit of priority from Japanese Patent Application No. 2017-177538 filed on Sep. 15, 2017. The entire disclosures of all of the above applications are incorporated herein by reference.

### TECHNICAL FIELD

The present disclosure relates to an ultrasonic wave output device.

### BACKGROUND

Previously, there is known an ultrasonic wave output device that includes an ultrasonic wave generator, a horn and a holder. The ultrasonic wave generator is configured to output an ultrasonic wave, and the holder is made of rubber and covers the ultrasonic wave generator to limit transmission of vibrations of the ultrasonic wave generator to the horn

### SUMMARY

This section provides a general summary of the disclosure, and is not a comprehensive disclosure of its full scope or all of its features.

According to the present disclosure, there is provided an ultrasonic wave output device that includes at least one ultrasonic wave generator, a horn and a holder. The ultrasonic wave generator is configured to output an ultrasonic wave, which corresponds to an input signal, from a sound wave output surface of the ultrasonic wave generator in a predetermined propagation direction of the ultrasonic wave. The horn surrounds a space, which is located on a front side of the ultrasonic wave generator in the propagation direction. The holder is placed between the ultrasonic wave generator and the horn and is made of a softer material, which is softer than a material of the ultrasonic wave generator.

### BRIEF DESCRIPTION OF DRAWINGS

The drawings described herein are for illustrative purposes only of selected embodiments and not all possible implementations, and are not intended to limit the scope of the present disclosure.

FIG. 1 is a cross-sectional view of an ultrasonic wave output device taken along line I-I in FIG. 2 according to a first embodiment.

FIG. 2 is a bottom view of the ultrasonic wave output device of the first embodiment.

FIG. 3 is an enlarged cross-sectional view of the ultrasonic wave output device of the first embodiment.

FIG. 4 is a graph showing a relationship between a projecting amount of a sound wave output surface and a sound pressure level.

FIG. 5 is a center cross-sectional view of an ultrasonic wave output device according to a second embodiment.

FIG. 6 is a center cross-sectional view of an ultrasonic wave output device according to a third embodiment.

### DETAILED DESCRIPTION

A previously proposed ultrasonic wave output device includes an ultrasonic wave generator and a horn while the ultrasonic wave generator is configured to output an ultrasonic wave, and a holder, which is made of rubber, covers the ultrasonic wave generator to limit transmission of vibrations of the ultrasonic wave generator to the horn.

As a result of the extensive study of the inventor of the present application, the following disadvantage of one such ultrasonic wave output device is found. That is, in this ultrasonic wave output device, the ultrasonic wave generator is entirely held by the holder, so that vibrations of the ultrasonic wave generator, which generate the ultrasonic waves, are limited, and thereby the sound waves, which are outputted from the ultrasonic wave generator, are disadvantageously attenuated.

An ultrasonic wave output device according to one aspect of the present disclosure includes at least one ultrasonic wave generator, a horn and a holder. The ultrasonic wave generator is configured to output an ultrasonic wave, which corresponds to an input signal, from a sound wave output surface of the ultrasonic wave generator in a predetermined propagation direction of the ultrasonic wave.

The horn surrounds a space, which is located on a front side of the ultrasonic wave generator in the propagation direction. The horn is configured such that a size of the space, which is surrounded by the horn, is progressively increased toward the front side in the propagation direction. The holder is placed between the ultrasonic wave generator and the horn and is made of a softer material, which is softer than a material of the ultrasonic wave generator. The holder is configured to hold the ultrasonic wave generator in an unarrested state where an outer peripheral edge of the sound wave output surface is not arrested.

In the ultrasonic wave output device described above, since the holder holds the ultrasonic wave generator in the unarrested state where the outer peripheral edge of the sound wave output surface is not arrested, attenuation of the sound wave is limited while limiting the transmission of the vibration of the ultrasonic wave generator to the horn. Hereinafter, embodiments of the present disclosure will be described with reference to the drawings.

### 1. First Embodiment

### [1-1. Structure]

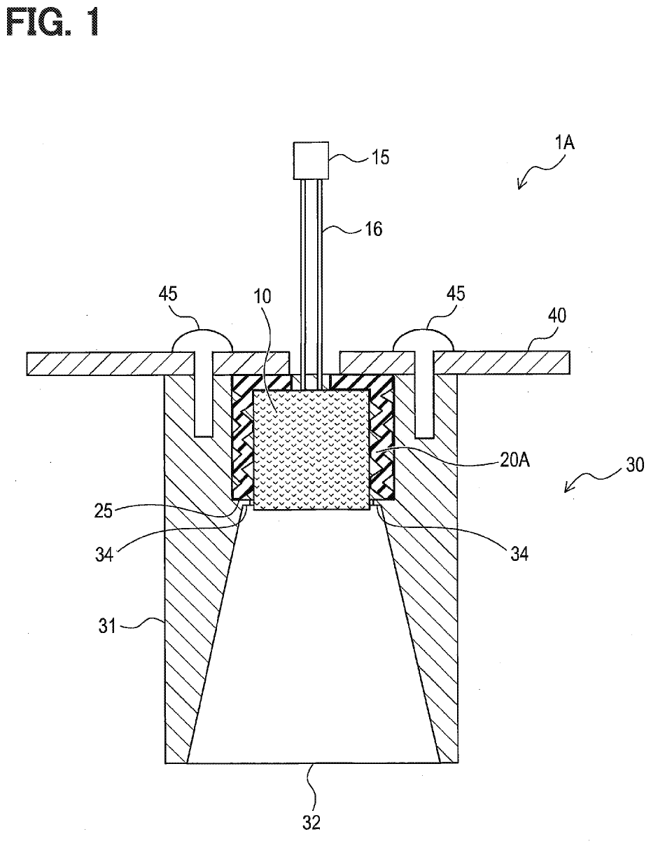

An ultrasonic wave output device 1A of a first embodiment shown in FIGS. 1 to 3 is a device that outputs an ultrasonic wave. The ultrasonic wave output device 1A is installed at, for example, a ceiling of an indoor facility, such as an indoor parking lot. The ultrasonic wave output device 1A is used in a system that provides position information using an ultrasonic wave in an environment where GPS (Global Positioning System) cannot be used.

The ultrasonic wave output device 1A includes an ultrasonic wave generator 10, a holder 20A and a horn 30. The ultrasonic wave output device 1A is fixed to a pedestal 40 with a plurality of screws 45.

The ultrasonic wave generator 10 is formed as a parametric speaker that modulates an ultrasonic wave and outputs the modulated ultrasonic wave. An input signal is inputted to the ultrasonic wave generator 10 from an ultrasonic wave amplifier (not shown) through a lead wire 16 having a connector 15, and the ultrasonic wave generator 10 outputs a sound wave having a relatively sharp directivity according to the input signal. As the input signal, there is inputted a signal for converting an ultrasonic wave having a constant amplitude and a predetermined frequency (e.g., 40 kHz) to a sound wave having a predetermined frequency by modulating an amplitude of a waveform of the ultrasonic wave having the constant amplitude and the predetermined frequency.

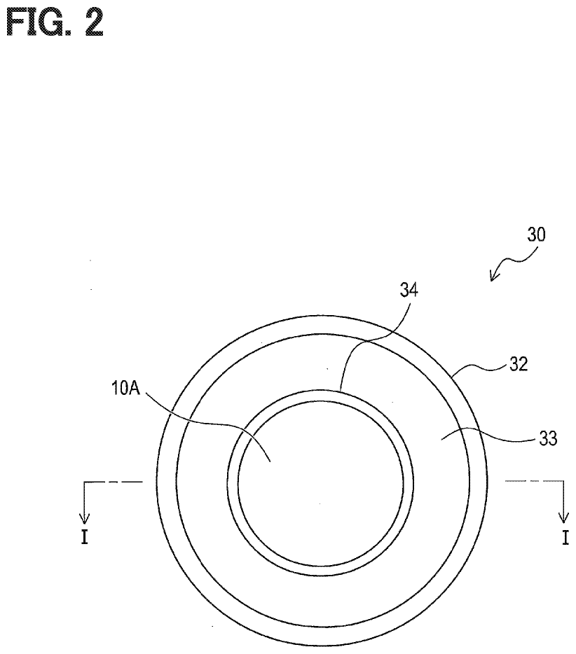

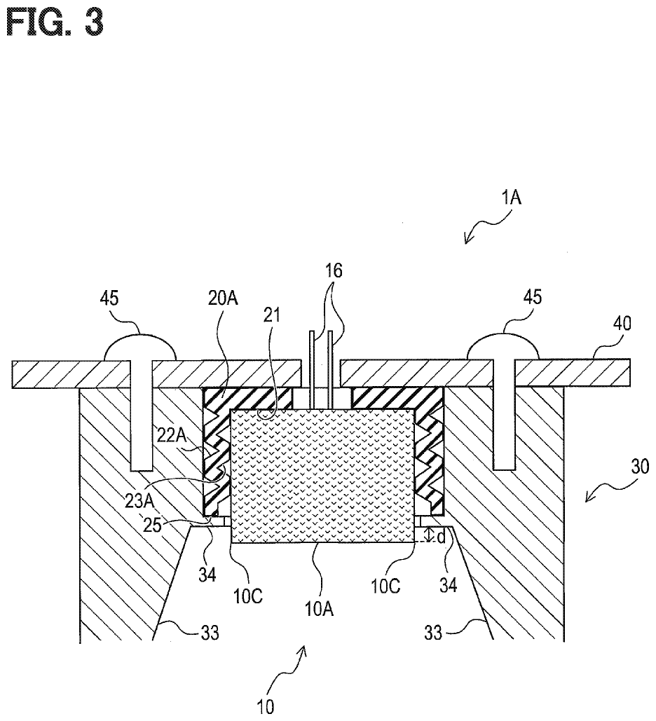

Here, as shown in FIGS. 1 to 3, the ultrasonic wave generator 10 is shaped in, for example, a columnar form, and the ultrasonic wave generator 10 outputs the ultrasonic wave, which corresponds to the input signal, from a sound wave output surface 10A, i.e., one end surface of the ultrasonic wave generator 10 in an propagation direction of the ultrasonic wave that is a direction perpendicular to the sound wave output surface 10A. The propagation direction is a downward direction in FIGS. 1 and 3 and a frontal direction in FIG. 2 while the frontal direction is a direction perpendicular to a plane of FIG. 2 toward a front side of the plane of FIG. 2. FIGS. 1 to 3 show an example where the single ultrasonic wave generator 10 is provided. Alternatively, a plurality of ultrasonic wave generators 10 may be provided.

The horn 30 is made of, for example, metal, such as stainless steel or an aluminum alloy. The horn 30 is configured to surround the ultrasonic wave generator 10 and also surround a space, which is located on a front side of the ultrasonic wave generator 10 in the propagation direction. An outer peripheral portion 31 of the horn 30, which extends in the propagation direction, is shaped in a cylindrical tubular form, and an inner peripheral portion 33 of the horn 30 is configured such that a size of the space, which is surrounded by the inner peripheral portion 33, progressively increases in the propagation direction. Specifically, as shown in FIG. 2, a cross-section of the inner peripheral portion 33, which is taken at any location of the inner peripheral portion 33 and is perpendicular to the propagation direction, is shaped in a form of a circle, and a diameter of this circle of the cross-section progressively increases toward a distal end portion 32 of the horn 30 that is an end portion of the horn 30 located on the front side in the propagation direction.

Furthermore, the horn 30 has a bottom surface portion 34. The bottom surface portion 34 is located at an ultrasonic wave generator 10 side end part of the space, which is opposite to the front side in the propagation direction. The bottom surface portion 34 has a surface that is perpendicular to the propagation direction. As shown in FIG. 3, the bottom surface portion 34 defines a space between the bottom surface portion 34 and the ultrasonic wave generator 10 to limit contact of the ultrasonic wave generator 10 to the bottom surface portion 34.

The holder 20A is placed between the ultrasonic wave generator 10 and the horn 30 and is located on the opposite side of the bottom surface portion 34, which is opposite to the front side in the propagation direction. The holder 20A is made of a softer material, which is softer than a material of an outer peripheral portion of the ultrasonic wave generator 10. The holder 20A is configured to hold the ultrasonic wave generator 10 in an unarrested state of an outer peripheral edge 10C of the sound wave output surface 10A where the outer peripheral edge 10C is not arrested by the holder 20A or any other member. The unarrested state is a state where the outer peripheral edge 10C has a space or a gap between the outer peripheral edge 10C and another object or a state where the outer peripheral edge 10C does not contact another object other than the air. The ultrasonic wave generator 10 is placed without directly contacting the horn 30.

The holder 20A is configured as a bellows-shaped member that alternately contacts the ultrasonic wave generator 10 and the horn 30 in the propagation direction and thereby forms a space between the ultrasonic wave generator 10 and the horn 30.

With this configuration, when the vibration generated by the ultrasonic wave generator 10 is transmitted to the holder 20A, the holder 20A damps the vibration to limit the transmission of the vibration to the horn 30 and thereby limit a loss of the output of the sound wave.

As to whether the holder 20A is hard or soft, a material, which can more easily damp the vibration at the time of generating the ultrasonic wave in comparison to another type of material, is said to be a softer material that is softer than the other type of material. In order to strictly measure whether the material is hard or soft, for example, a sample of an identical shape is prepared for each of the materials to be tested with respect to its hardness or softness, and one end of the sample is fixed, and a load is applied to the other end of the sample, and thereafter the other end of the sample is released to vibrate the sample. At this time, a material, which has a lower vibration frequency, may be defined as a softer material. For example, a resin material (e.g., rubber), urethane foam or relatively soft light metal (e.g., aluminum) may be used as the material of the holder 20A.

In the ultrasonic wave output device 1A, the sound wave output surface 10A of the ultrasonic wave generator 10 is configured to project toward the front side beyond the bottom surface portion 34 in the propagation direction. A projecting amount d of the sound wave output surface 10A, which projects from the bottom surface portion 34, is set in a range of, for example, 1 mm to 5 mm relative to a diameter of the sound wave output surface 10A, which is set to be about 17 mm.

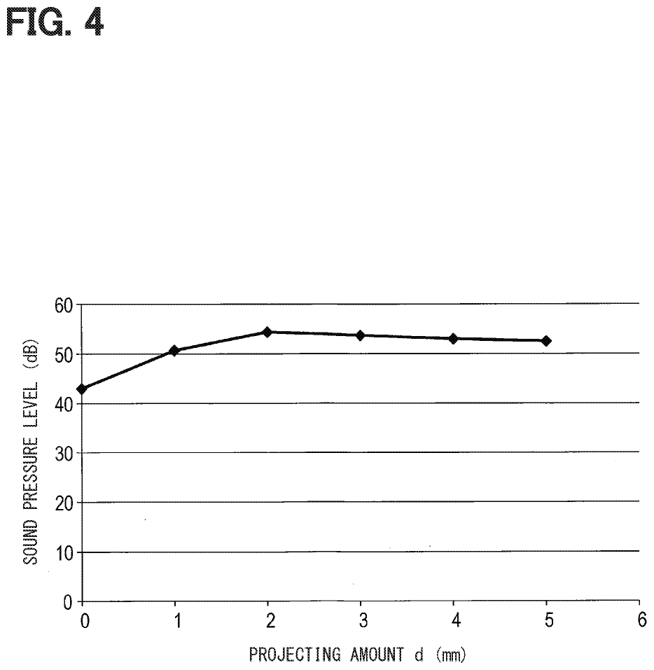

FIG. 4 shows a relationship between the projecting amount d and the level of the output of the sound wave. With respect to FIG. 4, it is understood that the output is improved when the projecting amount d is in the range of 1 mm to 5 mm in comparison to the output generated at the time when the projecting amount d is 0 (zero). It is assumed that this result is obtained due to the following reason. The outer peripheral edge 10C is not arrested to allow free vibration of the outer peripheral edge 10C, so that the sound wave is effectively radiated from the outer peripheral edge 10C.

Furthermore, it is assumed that in the structure where the projecting amount d is in the range of 1 mm to 5 mm, the propagation of the sound wave, which is released from the outer peripheral edge 10C, is less likely interfered with, for example, the bottom surface portion 34 to contribute in the improvement of the sound pressure level. Particularly, the result indicates that the output is maximized when the projecting amount d is 2 mm or around 2 mm.

### [1-3. Advantages]

The first embodiment described above provides the following advantages.

(1a) The ultrasonic wave output device 1A according to one aspect of the present disclosure includes the at least one ultrasonic wave generator 10, the horn 30 and the holder 20A. The at least one ultrasonic wave generator 10 is configured to output the ultrasonic wave, which corresponds to the input signal, from the sound wave output surface 10A in the predetermined propagation direction of the ultrasonic wave.

The horn 30 surrounds the space, which is located on the front side of the at least one ultrasonic wave generator 10 in the propagation direction. The horn 30 is configured such that the size of the space, which is surrounded by the horn 30, is progressively increased toward the front side in the propagation direction. When the horn 30 surrounds the space, which is located on the front side of the ultrasonic wave generator 10 in the propagation direction of the ultrasonic wave outputted from the ultrasonic wave generator 10, it may not be necessary to configure the horn 30 such that the size of the space, which is surrounded by the horn 30, is progressively increased toward the front side in the propagation direction. For instance, the horn 30 may be configured such that the size of the space, which is surrounded by the horn 30, is kept constant in the propagation direction. Alternatively, the horn 30 may be configured such that the size of the space, which is surrounded by the horn 30, is progressively reduced in the propagation direction. The holder 20A, 20B, 20C is placed between the ultrasonic wave generator 10 and the horn 30 and is made of the softer material, which is softer than the material of the ultrasonic wave generator 10. The holder 20A, 20B, 20C is configured to hold the ultrasonic wave generator 10 in the unarrested state where the outer peripheral edge 10C of the sound wave output surface 10A is not arrested.

In the ultrasonic wave output device 1A described above, since the holder 20A holds the ultrasonic wave generator 10 in the unarrested state where the outer peripheral edge 10C of the sound wave output surface 10A is not arrested, attenuation of the sound wave is limited while limiting the transmission of the vibration of the ultrasonic wave generator 10 to the horn 30.

(1b) In the ultrasonic wave output device 1A, the ultrasonic wave generator 10 is configured to project in the propagation direction beyond the end portion 25 of the holder 20A, which is located on the front side in the propagation direction. More specifically, the horn 30 has the bottom surface portion 34 that is located at an opposite side of the space, which is opposite to the front side in the propagation direction, and the bottom surface portion 34 has the surface that is perpendicular to the propagation direction. Furthermore, the sound wave output surface 10A of the ultrasonic wave generator 10 projects toward the front side beyond the bottom surface portion 34 in the propagation direction.

In the ultrasonic wave output device 1A, the sound wave output surface 10A projects toward the front side in the propagation direction beyond the end portion 25 of the holder 20A, which is located on the front side in the propagation direction, and the bottom surface portion 34, so that the sound pressure of the sound wave outputted from the ultrasonic wave output device 1A can be improved as indicated by the result of the experiment described above.

### 2. Second Embodiment

[2-1. Differences relative to First Embodiment]

A basic structure of an ultrasonic wave output device 1B of a second embodiment is similar to that of the first embodiment. Therefore, hereinafter, differences of the ultrasonic wave output device 1B of the second embodiment, which are different from the first embodiment, will be described. The reference signs, which are the same as those of the first embodiment, indicate the same structural portions, and the description of these structural portions described above should be referred.

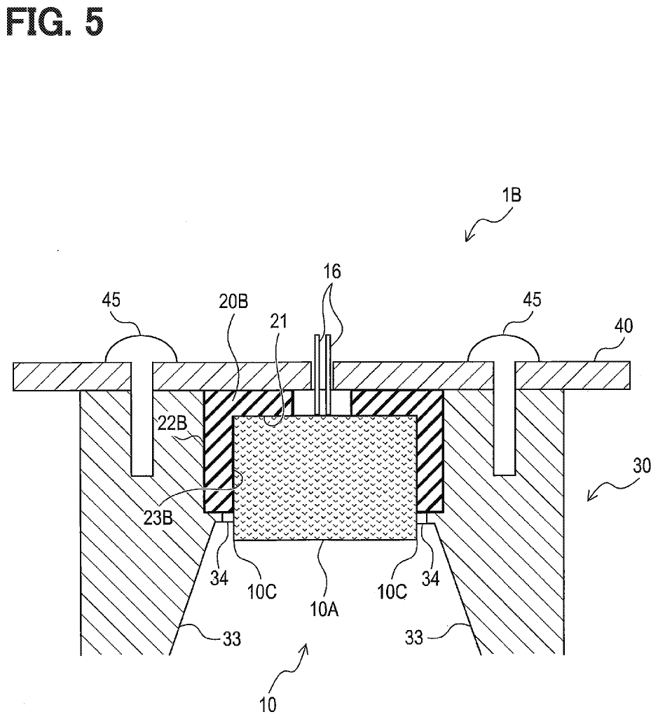

In the first embodiment, the holder 20A, which is the bellows-shaped member, is provided. The second embodiment differs from the first embodiment with respect to that a holder 20B shown in FIG. 5 is provided in place of the holder 20A.

### [2-2. Structure and Advantages]

The holder 20B shown in FIG. 5 is configured to continuously contact the ultrasonic wave generator 10 and the horn 30 without forming a space between the holder 20B and the ultrasonic wave generator 10 and between the holder 20B and the horn 30. A material of the holder 20B may be the same as that of the holder 20A or may be a gel-like substance that more easily damps the vibration.

According to the second embodiment described above, the following advantage can be achieved besides the advantage (1a) of the first embodiment discussed above. (2a) In the ultrasonic wave output device 1B described above, the holder 20B is configured to continuously contact the ultrasonic wave generator 10 and the horn 30 without forming the space between the holder 20B and the ultrasonic wave generator 10 and between the holder 20B and the horn 30.

According the ultrasonic wave output device 1B, the shape of the holder 20B can be simplified, so that the manufacturing of the holder 20B can be eased.

### 3. Third Embodiment

### [3-1. Differences Relative to First Embodiment]

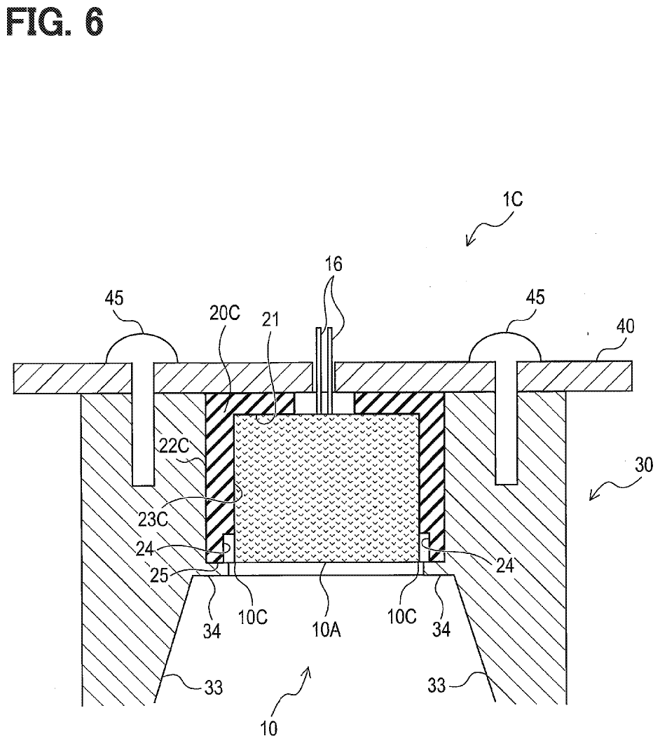

An ultrasonic wave output device 1C of a third embodiment differs from that of the first embodiment with respect to that a holder 20C shown in FIG. 6 is provided in place of the holder 20A.

### [3-2. Structure and Advantages]

As shown in FIG. 6, the ultrasonic wave output device 1C is configured such that the sound wave output surface 10A and the end portion 25 of the holder 20C, which is located on the front side in the propagation direction, are placed at a common plane such that the sound wave output surface 10A does not project from the bottom surface portion 34. However, a cutout 24 is formed at the inner peripheral surface of the end portion 25 of the holder 20C.

The cutout 24 is shaped in a form of cut that is formed at the holder 20C such that a space (gap) is formed by the cutout 24 between the holder 20C and the outer peripheral edge 10C of the ultrasonic wave generator 10. The form of cut does not actually require cutting the holder 20C. That is, it is only required that an inner diameter of a portion of the holder 20C, at which the cutout 24 is formed, is increased in comparison to an inner diameter of another portion of the holder 20C, at which the cutout 24 is not formed.

According to the third embodiment described above, the following advantage can be achieved besides the advantage (1a) of the first embodiment discussed above.

(3a) The ultrasonic wave output device 1C described above further includes the cutout 24 that is shaped in the form of cut located at the inner periphery of the end portion of the holder 20C, which is placed on the front side in the propagation direction.

In the ultrasonic wave output device 1C, since the cutout 24 is formed at the holder 20C, arresting of the outer peripheral edge 10C by the holder 20C is limited. Therefore, attenuation of the sound wave is limited while limiting the transmission of the vibration of the ultrasonic wave generator 10 to the horn 30.

### 4. Other Embodiments

Although the embodiments of the present disclosure have been described, the present disclosure should not be limited to the above embodiments and may be implemented in various other forms.

(4a) In the above embodiments, there are described the examples where the single ultrasonic wave generator 10 is used. Alternatively, a plurality of ultrasonic wave generators 10 may be used. In such a case, the plurality of ultrasonic wave generators 10 may be configured as a group of generators, which are entirely surrounded by the holder 20A, 20B, 20C. Even in this way, the advantage, which is similar to the advantage (1a) discussed above, can be achieved.

(4b) A plurality of functions of one component of any one of the above-described embodiments may be achieved by a plurality of components, or one function of one component may be fulfilled by a plurality of components. Alternatively, a plurality of functions of a plurality of components may be achieved by one component, or one function fulfilled by a plurality of components may be achieved by one component. Furthermore, the configuration of the above-described embodiment(s) may be partly omitted. Moreover, at least a part of the configuration of any one of the above-described embodiments may be added to the configuration of another one of the above-described embodiments or may replace a corresponding part of the latter.

(4a) Besides the ultrasonic wave output device 1A, 1B, 1C described above, the present disclosure may be implemented in various other forms, such as a system that includes the ultrasonic wave output device 1A, 1B, 1C as its component.

Furthermore, the cutout 24 of the holder 20C of the third embodiment, which is shaped in the form of cut, may be formed at the inner periphery of the end portion of the holder 20B of the second embodiment, which is placed on the front side in the propagation direction.

Furthermore, the sound wave output surface 10A of the ultrasonic wave generator 10 of the third embodiment may project on the front side of the bottom surface portion 34 in the propagation direction.

1. An ultrasonic wave output device comprising:
at least one ultrasonic wave generator that is configured to output an ultrasonic wave, which corresponds to an input signal, from a sound wave output surface of the ultrasonic wave generator in a predetermined propagation direction of the ultrasonic wave;
a horn that surrounds a space, which is located on a front side of the ultrasonic wave generator in the propagation direction, wherein the horn is configured such that a size of the space, which is surrounded by the horn, is progressively increased toward the front side in the propagation direction; and
a holder that is placed between the ultrasonic wave generator and the horn and is made of a softer material, which is softer than a material of the ultrasonic wave generator, wherein:
the holder is configured to hold the ultrasonic wave generator in an unarrested state where an outer peripheral edge of the sound wave output surface is not arrested;
the horn has a bottom surface portion that is located at an opposite side of the space, which is opposite to the front side in the propagation direction, wherein the bottom surface portion has a surface that is perpendicular to the propagation direction;
the bottom surface portion is located on the front side of the holder in the propagation direction; and
the sound wave output surface of the ultrasonic wave generator projects on the front side of the bottom surface portion in the propagation direction.

2. The ultrasonic wave output device according to claim 1, wherein the holder has a cutout that is shaped in a form of cut located at an inner periphery of an end portion of the holder, which is placed on the front side in the propagation direction.

3. The ultrasonic wave output device according to claim 1, wherein the ultrasonic wave generator is configured to project toward the front side in the propagation direction beyond an end portion of the holder, which is located on the front side in the propagation direction.

4. An ultrasonic wave output device comprising:
at least one ultrasonic wave generator that is configured to output an ultrasonic wave, which corresponds to an input signal, from a sound wave output surface of the ultrasonic wave generator in a predetermined propagation direction of the ultrasonic wave;
a horn that surrounds a space, which is located on a front side of the ultrasonic wave generator in the propagation direction, wherein the horn is configured such that a size of the space, which is surrounded by the horn, is progressively increased toward the front side in the propagation direction; and
a holder that is placed between the ultrasonic wave generator and the horn and is made of a softer material, which is softer than a material of the ultrasonic wave generator, wherein:
the holder is configured to hold the ultrasonic wave generator in an unarrested state where an outer peripheral edge of the sound wave output surface is not arrested; and
the holder has a cutout that is shaped in a form of cut located at an inner periphery of an end portion of the holder, which is placed on the front side in the propagation direction.

5. The ultrasonic wave output device according to claim 4, wherein:
the horn has a bottom surface portion that is located at an opposite side of the space, which is opposite to the front side in the propagation direction, wherein the bottom surface portion has a surface that is perpendicular to the propagation direction; and
the sound wave output surface of the ultrasonic wave generator projects on the front side of the bottom surface portion in the propagation direction.

6. The ultrasonic wave output device according to claim 4, wherein the ultrasonic wave generator is configured to project toward the front side in the propagation direction beyond an end portion of the holder, which is located on the front side in the propagation direction.

7. An ultrasonic wave output device comprising:
an ultrasonic wave generator that has a sound wave output surface configured to output an ultrasonic wave, which corresponds to an input signal;
a horn that surrounds a space, which is located on a front side of the ultrasonic wave generator in a propagation direction of the ultrasonic wave outputted from the ultrasonic wave generator; and
a holder that is placed between the ultrasonic wave generator and the horn and is made of a softer material, which is softer than a material of the ultrasonic wave generator, wherein the holder is configured to form a gap between an outer peripheral edge of the sound wave output surface and the holder and hold the ultrasonic wave generator.

8. The ultrasonic wave output device according to claim 7, wherein:
the horn has a bottom surface portion that is located at an opposite side of the space, which is opposite to the front side in the propagation direction, wherein the bottom surface portion has a surface that is perpendicular to the propagation direction; and
the sound wave output surface of the ultrasonic wave generator projects on the front side of the bottom surface portion in the propagation direction.

9. The ultrasonic wave output device according to claim 7, wherein the holder has a cutout that is shaped in a form of cut located at an inner periphery of an end portion of the holder, which is placed on the front side in the propagation direction.

10. The ultrasonic wave output device according to claim 7, wherein the ultrasonic wave generator is configured to project toward the front side in the propagation direction beyond an end portion of the holder, which is located on the front side in the propagation direction.
